(19) United States
(12) Patent Application Publication
(10) Pub. No.: US 2009/0096957 A1
(43) Pub. Date: Apr. 16, 2009

(54) Liquid Crystal Display Device

(76) Inventors: Ikuo Hiyama, Hitachinaka (JP); Akitoyo Konno, Hitach (JP); Makoto Abe, Hitachioota (JP); Akio Idei, Hatano (JP); Kaoru Katayama, Hatano (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/251,541

(22) Filed: Oct. 15, 2008

(30) Foreign Application Priority Data
Oct. 15, 2007 (JP) JP2007-268412

(51) Int. Cl. G02F 1/13357

(52) U.S. Cl. 349/65

(57) ABSTRACT

To provide a liquid crystal display device having excellent uniformity in the brightness so that the performance of displays of liquid crystal can be increased.

A liquid crystal display device is provided with: a support member: a heat releasing member provided on this support member; a light guiding plate 121 provided on a rear surface of a liquid crystal panel; and a light source module 124 which is thermally secured to the heat releasing member so as to face an entrance surface 121a formed on one or two sides in the direction of the length of the light guiding plate 121 and has a light source for emitting a light beam toward the entrance surface 121a, wherein the light source is covered with a lens 124c in the light source module 124, and the distance D between the lens 124c and the entrance surface 121a when the light source module 124 is not driven is set within a certain range.

The present application claims priority over Japanese Application JP2007-268412 filled on Oct. 15^{th}, 2007, the contents of which are hereby incorporated into this application by reference.

### BACKGROUND OF THE INVENTION

(1) Field of the Invention

The present invention relates to a liquid crystal display.

(2) Related Art Statement

In recent years, use of light emitting plasma display panels and non-light emitting liquid crystal display devices instead of CRT's (cathode ray tubes) as displays has been increasing.

From among these, liquid crystal display devices use a liquid crystal panel as a transmission type light modulation element, and the rear surface is provided with an illuminating device (also referred to as backlight), and the liquid crystal panel is illuminated with light. In addition, the liquid crystal panel forms an image by controlling the transmittance of light emitted from the backlight.

One feature of liquid crystal display devices is that they can be made thin in comparison with CRT's, and in recent years, thinner liquid crystal display devices have been in demand. Thus, Patent Document 1, for example, discloses a technology for a sidelight system having a configuration where LED's (light emitting diodes) are used for the light source of the backlight, and this light source is placed to the side of the liquid crystal panel instead of on the rear of the backlight, so that the rear surface of the liquid crystal panel is illuminated with light by means of a light guiding plate.

(Patent Document 1) Japanese Unexamined Patent Publication 2006-156324 (see FIG. 1)

### SUMMARY OF THE INVENTION

### Problem to Be Solved By the Invention

In the above described sidelight system, there is a risk that the brightness may become inconsistent and the efficiency with which light enters may lower due to fluctuation in the dimensions as a result of thermal expansion of the components as the size of the liquid crystal panel increases.

In particular, the positional relationship between the light source and the light guiding plate tends to easily change due to the difference in temperature between when the light is on and when the light is off. Here, when the light source and the light guiding plate make close contact due to the change in the positional relationship resulting from thermal expansion, the conditions for total reflection are lost, and thus the uniformity of the brightness is affected. In addition, there is a risk that the light guiding plate may become warped when the light guiding plate makes close contact with the light source.

In addition, it has been desired to attach the light source directly to a heat releasing member provided in liquid crystal display devices in order to reduce the number of steps for attaching the light source and the number of members for attachment. In particular, LED's have excellent heat releasing properties, and therefore, though it is desirable to thermally fix LED's to a heat releasing member, the fluctuation in the dimensions resulting from thermal expansion of the above described components becomes significant, and thus, it becomes more difficult to set the positional relationship between the light source and the light guiding plate.

The present invention is provided in order to solve these problems, and an object is to provide a liquid crystal display device having excellent uniformity in the brightness, so that the display performance of the liquid crystal can be improved.

### Means for Solving Problem

In order to solve the above described problems, the present invention provides a configuration where the above described light source is covered with a lens in the above described light source module, and the distance D between the above described lens and the above described entrance surface when the above described light source module is not driven is set within a range found using the following formulas (1) and (2):

{(□×L1)−(□×L2)}n×□T=D1 (1)

D1□D□D1×3 (2)
□: coefficient of thermal expansion of light guiding plate
L1: length of light guiding plate
□: coefficient of thermal expansion of support member
L2: length of support member in direction of length of light guiding plate
n: variable (1 in case where entrance surface formed on one side, ½ in case where entrance surface formed on two sides)
□T: difference in temperature (temperature of heat releasing member−ambient temperature around liquid crystal display device)

### Effects of the Invention

According to the present invention, an appropriate distance can be maintained between the lens of the light source module and the entrance surface of the light guiding plate, and thus, a liquid crystal display device having excellent uniformity in the brightness, so that the performance of displays of liquid crystal can be increased, can be gained.

### BRIEF DESCRIPTION OF THE DRAWINGS

FIG. 1 is an exploded perspective diagram showing the configuration of the liquid crystal display device according to the present embodiment;

FIG. 2 is a cross sectional diagram along line X-X in FIG. 1;

FIG. 3(a) is a diagram showing the arrangement of wires and drive circuits on a liquid crystal panel;

FIG. 3(b) is a diagram showing the arrangement of a TFT and a pixel electrode;

FIG. 4(a) is a diagram showing the arrangement of light sources and light guiding plates;

FIG. 4(b) is a diagram showing a light source;

FIG. 5 is a cross sectional diagram showing an enlargement of the main portion;

FIG. 6(a) is a graph showing the lower limit value for the distance when the light source module is placed on the short side of the light guiding plate;

FIG. 6(b) is a graph showing the lower limit value for the distance when the light source module is placed on the long side of the light guiding plate;

FIG. 7(a) is a graph showing the relationship between the ratio of the thickness of the light guiding plate to the diameter of the lens and the efficiency with which light enters; and

FIG. 7(b) is a graph showing the relationship between the ratio of the diameter of the lens to the size of the chip and the efficiency with which light enters.

### EXPLANATION OF SYMBOLS

1 liquid crystal display device

101 heat sink

107a inlets

107b outlets

120 liquid crystal panel

120a signal wire driving circuit

120b scanning wire driving circuit

120c signal wire

120d scanning wire

120e TFT

120f liquid crystal

120g pixel electrode

120h counter electrode

121 light guiding plate

121a entrance surface

121b exit surface

122 lower chassis (support member)

124 light source module

123 substrate

124 light source module

124a LED

124b wire pattern

124c lens

125 drive portion

125a control device

125b DC/DC power supply

131 first rubber cushion

132 second rubber cushion

133 buffering body

134 optical sheet

135 first reflective sheet

136 second reflective sheet

137 first frame

137a inlets

137b outlets

138 second frame

139 upper chassis

D distance

### DETAILED DESCRIPTION OF THE INVENTION

### Best Mode for Carrying Out the Invention

In the following, the best mode for carrying out the invention is described in detail in reference to the drawings.

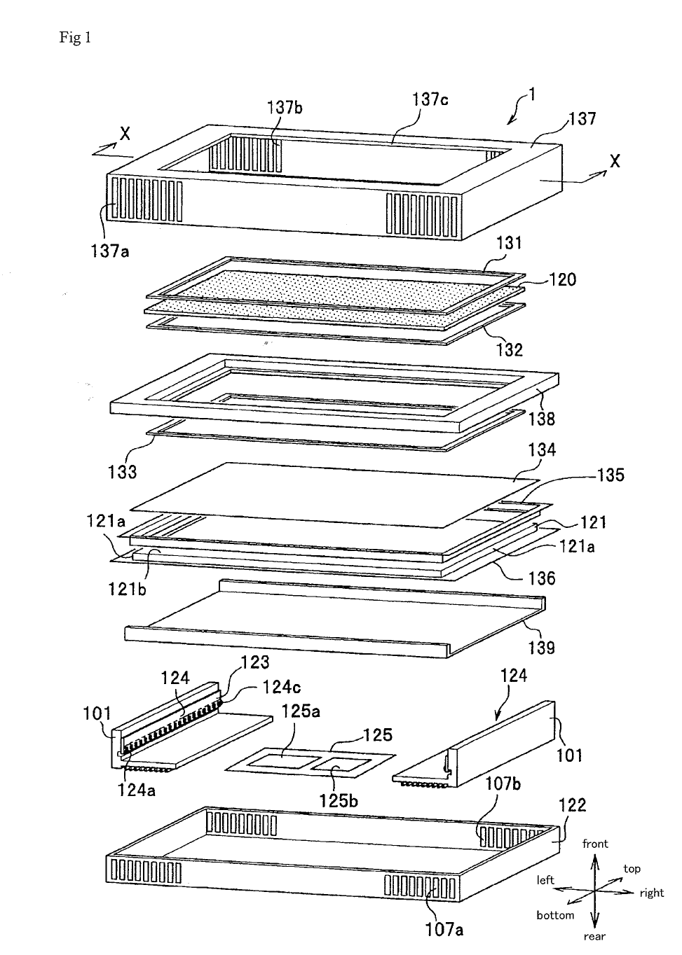

In the present embodiment, as shown in FIG. 1, the top, bottom, left, right, front and rear are defined with the display screen of a liquid crystal panel 120 as a reference.

As shown in FIG. 1, the liquid crystal display device 1 in the present embodiment is formed of a liquid crystal panel 120, a light guiding plate 121, a lower chassis 122, which is a support member, light source modules 124, lenses 124c which cover the light source of the light source modules 124, substrates 123 for mounting a light source, and a heat sink 101, which is a heat releasing member. Furthermore, the liquid crystal display device 1 is provided with a first frame 137, a first rubber cushion 131, a second rubber cushion 132, a second frame 138, an optical sheet 134, a first reflective sheet 135, a second reflective sheet 136 and an upper chassis 139.

The light guiding plate 121, described in detail below, is placed on the rear surface of the liquid crystal panel 120, and substrates 123 which form light source modules 124 are placed on the left and right side in the direction of the length of the light guiding plate 121. That is to say, light beams from the light source modules 124 on the two sides, left and right, enter the light guiding plate 121. Here, the sides of the light guiding plate 121 along which the light source modules 124 are placed are referred to as entrance surfaces 121a. In addition, the surface of the liquid crystal panel 120 is referred to as exit surface 121b.

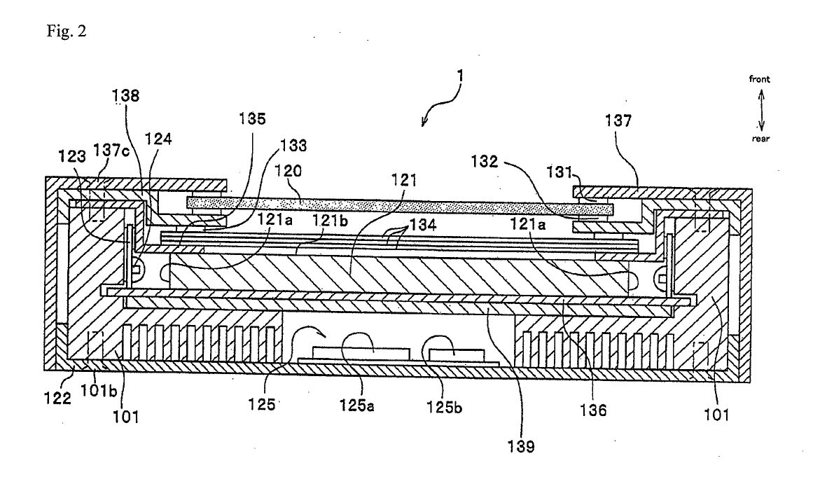

In addition, as shown in FIG. 2, a space is created between the light guiding plate 121 and the lower chassis 122, and the heat sink 101 extends into this space.

The liquid crystal panel 120 has a configuration where liquid crystal is sandwiched between two glass substrates, and the orientation of the liquid crystal molecules which make up the liquid crystal is controlled so that the liquid crystal functions as an optical shutter for controlling transmission and blocking of light emitted from the light guiding plate 121.

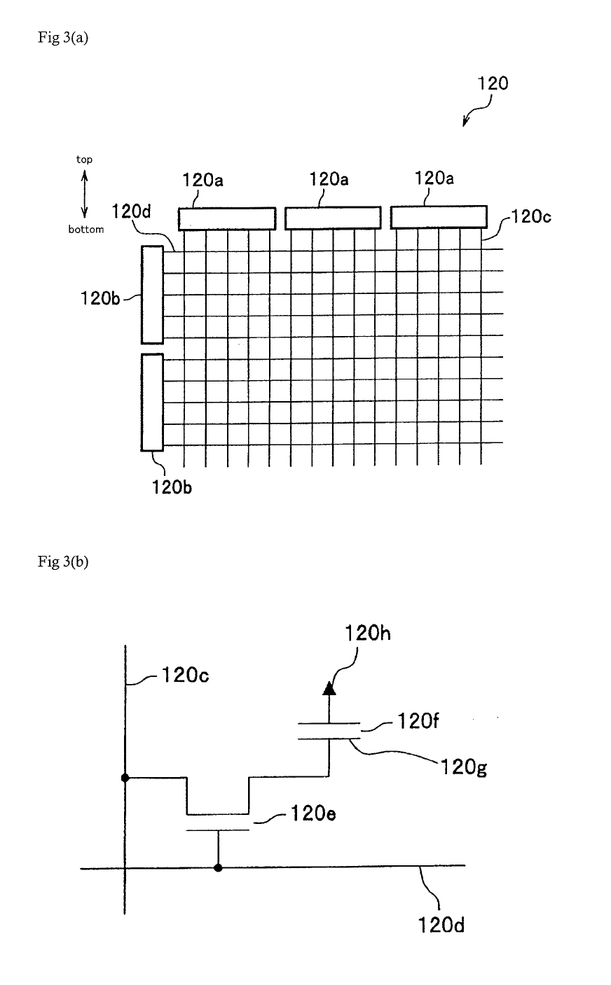

As shown in FIG. 3(a), signal wires 120c and scanning wires 120d are provided in grid form on the liquid crystal panel 120, which has signal wire driving circuits 120a for driving the signal wires 120c and scanning wire driving circuits 120b for driving the scanning wires 120d.

In addition, as shown in FIG. 3(b), TFT's 120e for driving the liquid crystal 120f are connected at the intersections between the signal wires 120c and the scanning wires 120d. When a positive voltage is applied to a scanning wire 120d, the TFT's 120e electrically connect the signal wires 120c and the pixel electrodes 120g. At this time, a voltage corresponding to the image data is applied to the pixel electrodes 120g from the signal wire 120c so that the shutter for the liquid crystal 120f opens or closes in accordance with the voltage between the pixel electrodes 120g and the counter electrodes 120h. When the shutter for the liquid crystal 120f opens, light emitted through the exit surface 121b of the light guiding plate 121 shown in FIG. 1 transmits, making the pixel bright. When the shutter for the liquid crystal 120f is not open, the pixel becomes dark.

The relationship between the opening and closing of the shutter for the liquid crystal 120f and the voltage applied to the liquid crystal (which is almost the same as the voltage between the pixel electrode 120g and the counter electrode 120h) depends on the so-called display mode of the liquid crystal 120f. In an example of the display mode for a liquid crystal panel 120 (see FIG. 1) for a general television receiver, when the absolute value of the voltage applied to the liquid crystal 120f is great (approximately 5 V), the pixel becomes bright, and when it is small (approximately 0 V), the pixel becomes dark. At this time, for voltages between 0 V and 5 V, the greater the absolute value of the voltage is, the brighter the pixel becomes, though the relation is non-linear. In addition, gradation can be displayed by dividing the range between 0 V and 5 V into appropriate sections. It goes without saying that there are no limitations in these display modes according to the present invention.

In addition, in the case where a negative voltage is applied to the scanning wire 120d connected to a TFT 120e, the connection between the signal wire 120c and the pixel electrode 120g becomes of a state of high resistance, so that the voltage applied to the liquid crystal 120f can be maintained.

As described above, the liquid crystal 120f is controlled by the voltage applied across the scanning wire 120d and the signal wire 120c in the configuration.

The scanning wire driving circuits 120b function to scan the pixels with a certain period, so that a predetermined voltage is applied to the scanning wires 120d one by one from the top to the bottom, for example. In addition, signal wire driving circuits 120a apply a voltage corresponding to the respective pixels connected to the scanning wire 120d to which a predetermined voltage is applied by a scanning wire driving circuit 120b to the respective signal wires 120c.

In this configuration, the scanning wire 120d to which a voltage is applied can set bright pixels and dark pixels. In addition, as the scanning wire driving circuits 120b scan the pixels, the signal wire driving circuits 120a control the voltage applied to the respective signal wires 120c, and thus, bright pixels and dark pixels can be set for all of the scanning wires 120d, and an image can be formed on the liquid crystal panel 120.

Here, the signal wire driving circuits 120a and the scanning wire driving circuits 120b are controlled by a control device 125a (see FIG. 1), for example, in the configuration.

The control device 125a functions to manage an image signal to be displayed on the liquid crystal panel 120 as information on the brightness for each portion of the liquid crystal 120f (see FIG. 3(b)). In addition, the scanning wire driving circuits 120b are controlled so that the pixels are scanned when a predetermined voltage is applied to the scanning wires 120d one by one from the top to the bottom, and at the same time, the signal wire driving circuits 120a are controlled so that a predetermined voltage is applied to the respective signal wires 120c corresponding to the information on the brightness of the signal wire 120c on the scanning wire 120d to which a predetermined voltage is applied in the configuration.

Returning to FIG. 1, the light guiding plate 121 is made of a transparent resin, such as acryl, and functions to convert light beams emitted from the light source module 124 (point light source) to a surface light source. In addition, as shown in FIG. 2, the light guiding plate 121 is placed on the rear surface of the liquid crystal panel 120 with the second frame 138, the second rubber cushion 132 and the optical sheet 134 in between, and functions to convert light beams emitted by the below described LED's 124a in the light source module 124 (point light source) to a surface light source. Therefore, the substrates 123 that form the light source modules 124 are placed on the left and right side of the light guiding plate 121. Here, as described above, the light guiding plate 121 has an entrance surface 121a and an exit surface 121b.

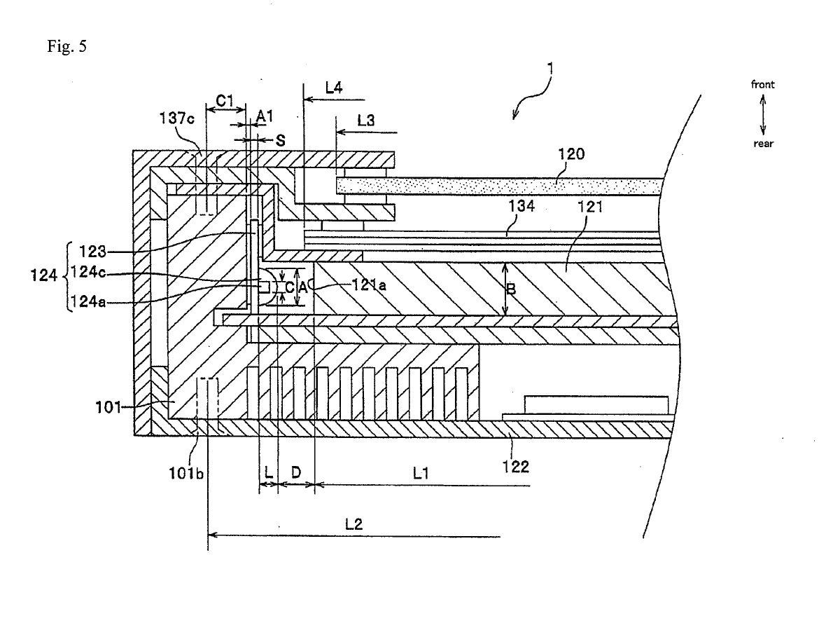

Here, in the present embodiment, as shown in FIG. 5, the length L1 of the light guiding plate 121 is greater than the length L3 of the liquid crystal panel 120, and the length L4 of the optical sheet 134 is greater than the length L1 of the light guiding plate 121.

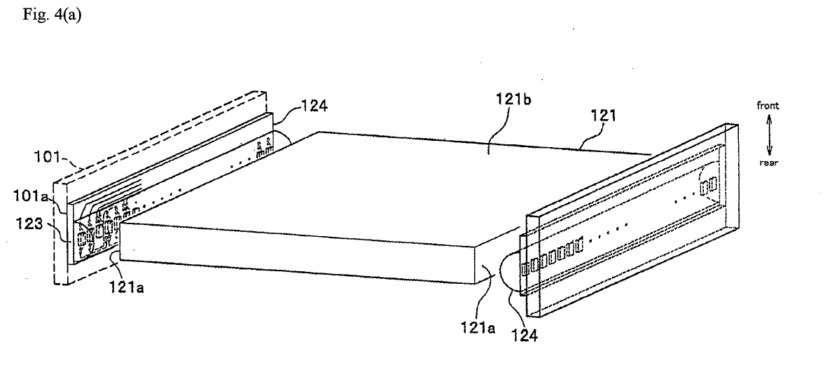

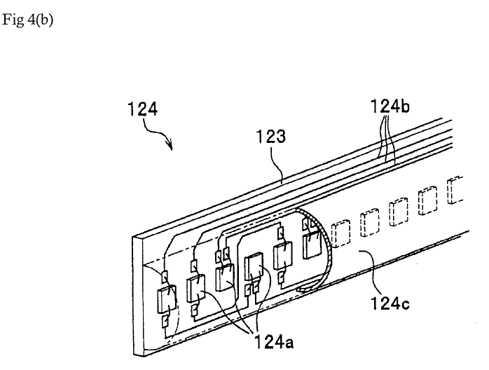

In addition, as shown in FIG. 4(a), the light source modules 124 are provided along the entrance surfaces 121a of the light guiding plate 121 so that light beams emitted by the light source modules 124 enter the light guiding plate 121 through the entrance surfaces 121a in the structure. Here, the light source modules 124 are formed so that it is possible for the liquid crystal panel 120 (see FIG. 1) to emit light for displaying an image.

As shown in FIG. 4(b), a number of LED's 124a are secured to the substrates 123 in the light source modules 124 (three colors: R (red), G (green) and B (blue), for example, alternate), so that the LED's are electrically connected to the wire patterns 124b formed on the substrates 123 through bonding or the like. Furthermore, lenses 124c made of a silicon resin, for example, for appropriately scattering light are provided so as to cover the top of the light emitting surfaces. These light source modules 124 are formed so that LED's 124a emit light when a current/voltage is supplied via the wire patterns 124b. As the substrates 123, ceramic substrates having low thermal resistance, for example, can be used, and the substrates 123 are secured so as to make contact with the heat sinks 101 via a thermally conductive adhesive member 101a, for example a silver paste, as shown in FIG. 4(a), so that the heat generated in the light source modules 124 can be effectively conveyed to the heat sinks 101. That is to say, the substrates 123 which form the light source modules 124 are thermally secured to the heat sinks 101.

Here, as shown in FIG. 5, the diameter A of the lenses 124c is set smaller than the thickness B of the light guiding plate 121. Here, the setting of the dimensions is not limited to this, and the diameter A of the lenses 124c may be the same as the thickness B of the light guiding plate 121.

As shown in FIG. 4(a), light beams that enter the light guiding plate 121 through the entrance surfaces 121a propagate while repeatedly reflecting inside the light guiding plate 121, are scattered by reflection dots, not shown, printed on the rear surface of the light guiding plate 121, and are emitted through the exit surface 121b on the front of the light guiding plate 121. Furthermore, as shown in FIG. 2, the second reflective sheet 136 is placed on the rear surface of the light guiding plate 121, so that light beams which exit through the rear surface of the light guiding plate 121 because of the failure to satisfy the conditions for total reflection return into the light guiding plate 121, and thus, the liquid crystal panel 120 is efficiently illuminated (see FIG. 1).

As described above, the present embodiment has such a configuration that the rear surface of the liquid crystal panel 120 is illuminated with light beams emitted through the exit surface 121b of the light guiding plate 121.

Returning again to FIG. 1, the lower chassis 122 is made of an aluminum alloy, for example, and placed on the rear surface of the liquid crystal display device 1 so as to function also as a rear surface member for the liquid crystal display device 1. The heat sinks 101 are secured to the front of the lower chassis 122 by means of screws 101b (see FIG. 5). In addition, inlets 107a for sucking in air are provided on the lower side of the lower chassis 122, and in addition, outlets 107b for discharging air are provided on the upper side of the lower chassis 122.

The first frame 137 is made of an aluminum alloy, for example, and placed on the front surface of the liquid crystal panel 120 so as to function also as a front cover for the liquid crystal display device 1. The first frame 137 is secured to the heat sinks 101 by means of screws 137c (see FIG. 2), and in such a form that there is an opening for the display area 137c through which the liquid crystal panel 120 is exposed. In addition, inlets 137a for sucking in air are provided on the lower side of the first frame 137, and in addition, outlets 137b for discharging air are provided on the upper side of the first frame 137.

When the first frame 137 and the lower chassis 122 are combined so that the housing for the liquid crystal display device is formed, the outlets 137b of the first frame 137 and the outlets 107b of the lower chassis 122 are connected, while the inlets 137a of the first frame 137 and the inlets 107a of the lower chassis 122 are connected in the configuration.

The first rubber cushion 131 is placed on the front surface of the liquid crystal panel 120 in such a manner as to function as a support member provided between the first frame 137 and the liquid crystal panel 120. In addition, the second rubber cushion 132 is placed on the rear surface of the liquid crystal panel 120 in such a manner as to function as a buffering member between the liquid crystal panel 120 and the second frame 138.

The second frame 138 functions as a support for the liquid crystal panel 120, and at the same time, intervenes between the heat sinks 101 and the liquid crystal panel 120 so as to function as a heat insulating material for preventing heat from the heat sinks 101 from being conveyed to the liquid crystal panel 120.

The optical sheet 134 is placed on the rear surface of the second frame 138 so as to function to provide directionality for light emitted from the light guiding plate 121, so that light becomes uniform within the plane and the brightness increases toward the front. Here, the number of optical sheets 134 is not limited, and in the present embodiment, three optical sheets 134 are provided, as shown in FIG. 2. In addition, a buffering body 133 made of an elastic member, for example one of rubber, is placed between the second frame 138 and the optical sheets 134, so that impact from the first frame 137, for example, is absorbed.

The first reflective sheet 135 is placed on the rear surface of the optical sheet 134. The first reflective sheet 135 functions to reflect light beams which do not enter the light guiding plate 121 from among light beams emitted from the light source modules 124 and make reflected light beams enter the light guiding plate 121, and also functions to make light beams emitted through the exit surface 121b of the light guiding plate 121 in the vicinity of the light source modules 124 return into the light guiding plate 121. In the vicinity of the light source modules 124, light emission of RGB is inconsistent, and thus, this portion cannot be used as a display surface. Therefore, light beams in the vicinity of the light source modules 124 are returned into the light guiding plate 121 by the first reflective sheet 135, so that loss of light can be reduced.

The second reflective sheet 136 is placed on the rear surface of the light guiding plate 121. The second reflective sheet 136 functions to reflect light which does not directly enter the light guiding plate 121 from among light beams emitted from the light source modules 124 and makes reflected light enter the light guiding plate 121, so that the efficiency with which light beams can be used can be increased, and at the same time, functions to make light beams which exit through the lower surface of the light guiding plate 121 due to failure to meet the conditions for total reflection return into the light guiding plate 121.

The heat sinks 101 are formed of a material having excellent heat conductivity, for example a metal material, such as copper or aluminum, and functions to efficiently release heat generated in the light source modules 124. In addition, the heat sinks 101 are connected to the surface of the substrates 123 on which the LED's 124a are not mounted using a thermally conductive adhesive member 101a (see FIG. 4(a)), for example, as described above, and function to release heat by conveying the heat generated in the light source modules 124 to the heat sinks 101.

Furthermore, the heat sinks 101 contain the liquid crystal panel 120 and the light guiding plate 121 inside a visual rectangular parallelepiped region that is circumscribed on the heat sinks 101, and thus, function to protect the liquid crystal panel 120 and the light guiding plate 121 when pressure is applied to the liquid crystal display device 1.

Here, the structure of the heat sinks 101 is in approximately L shape as viewed from the top, and as shown in FIG. 2, the bent portions of the heat sinks 101 are located between the light guiding plate 121 and the lower chassis 122.

Heat generated in the light source modules 124 is conveyed to the heat sinks 101 and diffuses along the surface of the heat sinks 101 located on the rear surface of the light guiding plate 121, and after that released into the air that flows between the light guiding plate 121 and the lower chassis 122. The air flows between the light guiding plate 121 and the lower chassis 122 from the bottom to the top as a result of natural convection.

In addition, outside air is sucked into the liquid crystal display device 1 through the inlets 137a in the first frame 137 (see FIG. 1) and the inlets 107a in the lower chassis 122 (see FIG. 1) and discharged through the outlets 137b in the first frame 137 and the outlets 107b in the lower chassis 122 (see FIG. 1).

As described above, in the present embodiment a space for releasing heat in the up-down direction relative to the display screen of the liquid crystal display panel 120, that is to say, an air path, is formed between the light guiding plate 121 and the lower chassis 122, as shown in FIG. 2. In addition, when air flows into the air path through the inlets 137a in the first frame 137 (see FIG. 1) and the inlets 107a in the lower chassis 122 (see FIG. 1), and out through the outlets 137b in the first frame 137 (see FIG. 1) and the outlets 107b in the lower chassis 122 (see FIG. 1) as a result of natural convection, the heat sinks 101 provided in the air path are cooled in the configuration.

Furthermore, a drive portion 125 is provided with a control device 125a for controlling the liquid crystal display device 1 (see FIG. 1) and a DC/DC power supply 125b for supplying a power supply voltage to the light supply modules 124 and the like. The control device 125a controls the liquid crystal panel 120, the light source modules 124 and the like and processes the image displayed on the liquid crystal display device 1, and is formed of a computer having a CPU (central processing unit), a RAM (random access memory) and a ROM (read only memory), programs, peripheral circuits and the like, not shown, and the device is driven by programs stored in the ROM.

As shown in FIG. 5, the liquid crystal display device 1 formed as described above (see FIG. 1) in the present embodiment is characterized that the distance D between the entrance surfaces 121a of the light guiding plate 121 and the lenses 124c of the light source modules 124 is set within a range found using the following formulas (1) and (2) when the light source modules 124 are not driven.

{(□×L1)−(□×L2)}n×□T=D1 (1)

D1□D□D1×3 (2)

Here, □ is the coefficient of thermal expansion of the light guiding plate 121, L1 is the length of the light guiding plate 121, □ is the coefficient of thermal expansion of the lower chassis 122, L2 is the length of the lower chassis 122 in the direction of the length of the light guiding plate 121, n is a variable (1 in the case where the entrance surface 121a is formed on one side, ½ in the case where the entrance surface 121a is formed on two sides; in the present embodiment, the entrance surface 121a is formed on the two sides, and therefore, the variable is ½), and □T is the difference in temperature (temperature of heat sinks 101−ambient temperature around liquid crystal display device 1).

The range for the distance D which is smaller than the value D1 gained using the formula (1) is excluded in the above described formula (2) because in the case where the distance D is set smaller than the value D1 gained using the formula (1), there is a risk that the lenses 124c and the entrance surfaces 121a of the light guiding plate 121 may make contact in spite of the design having a clearance between parts and the margin, thus making the efficiency with which light enters lower when the size of the light guiding plate 121 fluctuates as a result of thermal expansion when the light source modules 124 are driven.

Meanwhile, the range for the distance D which is more than three times greater than the value D1 gained using the formula (1) is excluded because in the case where the distance D is set greater than the value D1 as gained using the formula (1), there is a risk that the space between the lenses 124c and the entrance surfaces 121a of the light guiding plate 121 may become too large to lower the efficiency with which light enters when the size of the light guiding plate 121 fluctuates as a result of thermal expansion when the light source modules 124 are driven.

In contrast, in the case where the distance D is set within a range between the value D1 gained using the formula (1) an a value three times greater than D1, contact between the lenses 24c and the entrance surfaces 121a of the light guiding plate 121 can be avoided, and at the same time, the efficiency with which light enters can be prevented from lowering, even when the size of the light guiding plate 121 fluctuates as a result of thermal expansion when the light source modules 124 are driven.

Next, it is confirmed with concrete numeral values what conditions for the dimensions can allow for a necessary distance D in order to prevent interference between the entrance surfaces 121a of the light guiding plate 121 and the lenses 124c of the light source modules 124 between these.

Here, the lenses 124c are made of silicon, the heat sinks 101 are made of copper, and the lower chassis 122 is made of an aluminum alloy. In addition, the light guiding plate 121 is made of an acryl resin. The light source modules 124 having lenses 124c as described above are thermally secured to the heat sinks 101 through the substrates 123, and the lower chassis 122 is secured to the heat sinks 101 by means of screws 101b. That is to say, the light source modules 124 and the lower chassis 122 are secured via the heat sinks 101.

Here, the lower portion of the heat sinks 101 are formed so as to have a slit on the side facing the lower chassis 122, and thus, the heat sinks 101 and the lower chassis 122 are in such a state as to be almost completely thermally isolated. As a result, there is a difference in temperature between the heat sinks 101 and the lower chassis 122.

In addition, the light guiding plate 121 is made of acryl having a high coefficient of thermal expansion, as described above, and therefore, it is assumed that parts interfere when in an expanded state as a result of high temperatures. As a result of numeric analysis, it was found that the average temperature of the light guiding plate 121 is 63.6 □ when the LED's 124a emit heat at 50 W, and the average temperature of the lower chassis 122 is 73.1 □. Here, the ambient temperature is 25 □ at the time of assembly, and the temperature T1 of the light guiding plate 121 is 40 □ and the temperature □T2 of the lower chassis 122 53 □ when the difference in temperature from the ambient temperature of 25 □ is included as a margin of 10%.

The allowance in terms of the dimensions of the parts is as in Table 1. Here, a liquid crystal panel 120 of which the aspect ratio is 16:9 is used.

TABLE 1

| | allowance in terms |
|---|---|
| object member | of dimensions |
| distance between screw holes for | ±0.35 mm |
| attaching heat sinks dcp | |
| (2dcp = ±0.7:0.1% of long side of | |
| approximately 700 mm) | |
| heat sinks dcu | ±0.1 mm |
| thickness of substrates dan | ±0.1 mm |
| thickness of lenses dsi | ±0.03 mm |
| light guiding plate drp | ±0.35 mm |
| (drp = ±0.7:0.1% of long side of | |
| approximately 700 mm) | |

The total allowance in terms of the dimensions of the parts Ad of these parts is found as the sum of squares using the following formula (3).

Ad=√(dcp²+dcu²+dan²+dsi²+drp²)=0.516 mm (3)

Next, the amount of expansion □D at the time of high temperature on one side of the liquid crystal panel 120 is found. The amount of expansion □D can be found using the following formula (4).

□D=(□R−□W)/2+□C+□S+□L (4)

Here, □R is the amount of expansion of the light guiding plate 121, □W is the amount of expansion of the lower chassis 122, and “(□R−□W)/2” is the portion corresponding to the above described formula (1). □R can be found as □ (coefficient of thermal expansion of light guiding plate 121)×L1 (length of light guiding plate 121)×□T1, and □W can be found as □ (coefficient of thermal expansion of lower chassis 122)×L2 (length of lower chassis 122)×□T2.

In addition, □C is the amount of expansion of the heat sinks 101 in the length C1 between the surface of the heat sinks 101 where the substrates 123 are attached and the screw holes 101b for attachment (see FIG. 5), S is the amount of expansion of the substrates 123 in the light source modules 124, and L is the amount of expansion of the lenses 124C of the light source modules 124.

Table 2 shows the coefficient of thermal expansion of the object members.

TABLE 2
Coefficient of thermal expansion of object members

| | | coefficient of |
|---|---|---|
| object member | material | thermal expansion |
| lower chassis | aluminum alloy | 23.6 ppm/° C. |
| light guiding plate | acryl | 70.0 ppm/° C. |
| heat sinks | copper | 16.5 ppm/° C. |
| substrates | alumina | 7.7 ppm/° C. |
| lenses | silicone resin | 350.0 ppm/° C. |
| sheets | polyester | 15.0 ppm/° C. |

When the amount of expansion □D at the time of high temperatures is found from the concrete dimensions in the liquid crystal display device using the above described formula (4), □D=(2.17−0.918)/2+0.002+0.0003+0.023=0.652 mm.

Accordingly, the distance D between the entrance surfaces 121a of the light guiding plate 121 and the lenses 124c of the light source modules 124 has a relationship with the above described total allowance in terms of the dimensions of parts Ad and the above described amount of expansion □D at the time of high temperatures which satisfies the following formula (5).

D>Ad+□D (5)

Here, as described above, Ad is 0.516 mm and □D is 0.652 mm, and therefore, D>1.168 mm.

An error margin of 20% is taken into consideration in the results for the thus gained distance D, and the value of the distance D is set as D=1.168×1.2=1.40 mm.

Thus, the amount of expansion at the time of high temperatures is confirmed on the basis of the distance D taking an error margin of 20% into consideration, so that the results shown in Table 3 are gained, and when the above described distance D and the amount of expansion □T′, which is the sum of the total allowance in terms of the dimensions of the parts Ad and the amount of expansion at the time of high temperatures, are compared, the relationship is as shown in the following formula (6).

D>Ad+□T═ (6)

TABLE 3
Amount of expansion of subject members at time of high temperatures

| subject member | | symbol | numeral value |
|---|---|---|---|
| light guiding plate | original size | L1 | 721.4 |
| | amount of expansion | ΔR | 2.171 |
| lower chassis | original size | L2 | 733.8 |
| | amount of expansion | ΔW | 0.918 |
| heat sinks | original size | C1 | 2.2 |
| | amount of expansion | ΔC | 0.002 |
| silver paste | original size | A1 | 0.1 |
| | amount of expansion | ΔA | very small |
| substrates | original size | S | 1 |
| | amount of expansion | ΔS | 0.0003 |
| lenses | original size | L | 1.5 |
| | amount of expansion | ΔL | 0.023 |

| | | |
|---|---|---|
| difference in expansion at time of high | ΔT′ | 0.651 |
| temperatures (one side) | | |

Here, Ad is 0.516 mm and □T′ is 0.651 mm, as described above, and therefore, 0.516+0.651=1.167, and thus, D=1.4>1.167.

That is to say, the value of the distance D is greater than the amount of expansion □T′, which is the sum of the total allowance in the dimensions of the parts Ad and the amount of expansion at the time of high temperatures, and it could be confirmed that the distance D for preventing interference between the entrance surfaces 121a of the light guiding plate 121 and the lenses 124c of the light source modules 124 between these at the time of high temperatures was appropriate.

Meanwhile, in the above described formula (2), the range for the distance D is set between the value D1 gained using the formula (1) and a value three times greater than D1, and therefore, contact between the lenses 124c and the entrance surfaces 121a of the light guiding plate 121 can be avoided without fail in the case where the above described total allowance in terms of the dimensions of the parts Ad and the above described amount of expansion LED at the time of high temperatures are taken into consideration, even when the size of the light guiding plate 121 fluctuates as a result of thermal expansion when the light source modules 124 are driven.

In addition, the distance D secures a space which is effective at the time of assembly of the parts between the entrance surfaces 121a of the light guiding plate 121 and the lenses 124c of the light source modules 124, and thus, the efficiency of work increases, the productivity increases and the yield also increases. In addition, light emitted from the LED's 124a can be prevented from leaking out while maintaining the clearance between the entrance surfaces 121a of the light guiding plate 121 and the LED7s 124a small and constant, and thus, the efficiency with which light enters the light guiding plate 121 can be prevented from lowering. As a result, a preferable and predetermined brightness can be gained.

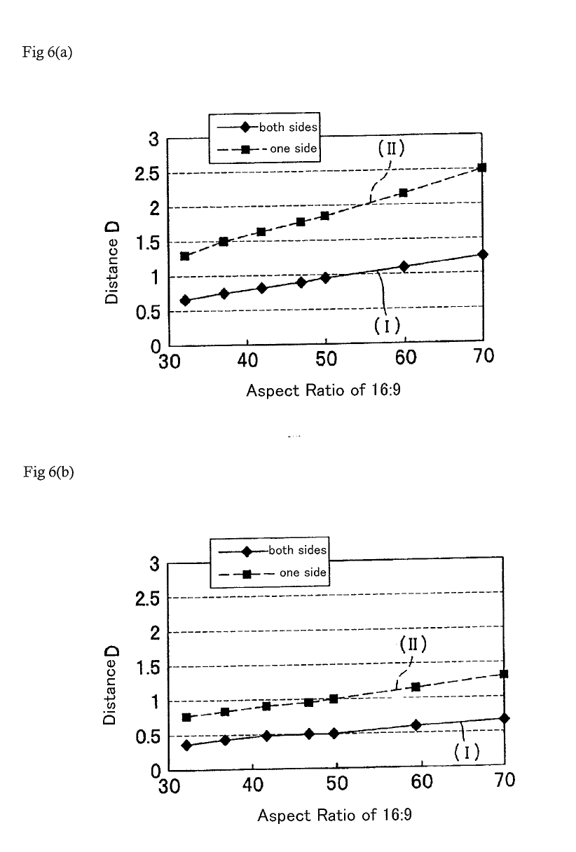

FIGS. 6(a) and 6(b) show concrete examples where the lower limit values are for the distance D required for each of the predetermined sizes for the liquid crystal panel 120 (for each size of the light guiding plate 121 used), and the solid line (I) in the graph indicates the arrangement of the light source modules 124 on the two sides of the light guiding plate 121 and the dashed line (II) in the graph indicates the arrangement of the light source module 124 on one side of the light guiding plate 121. In addition, the light guiding plate 121 used has an aspect ratio of 16:9, and FIG. 6(a) shows concrete examples where the light source modules 124 are placed on the short sides of the light guiding plate 121 and FIG. 6(b) shows concrete examples where the light source modules 124 are placed on the long sides of the light guiding plate 121.

In the actual setting for the distance D, the total allowance in terms of the dimensions of the parts Ad is added to the value of the gained distance D, as described above, and an error margin of 20% is taken into consideration for this, and thus, the distance D for preventing interference between the entrance surfaces 121a of the light guiding plate 121 and the lenses 124c of the light source modules 124 is appropriate between these at the time of high temperatures.

Incidentally, as shown in FIG. 5, the diameter A of the lenses 124c is set equal to or smaller than the thickness B of the light guiding plate 121, as described above, and therefore, loss of light can be prevented, and as a result, the efficiency with which light enters the light guiding plate 121 can be increased. That is to say, the smaller the diameter A of the lenses 124c is set relative to the thickness B of the light guiding plate 121, the greater the area of the entrance surfaces 121a of the light guiding plate 121 becomes relative to the lenses 124c, so that most of the light emitted from the LED's 124a directly enters the light guiding plate 121 and the efficiency with which light enters increases.

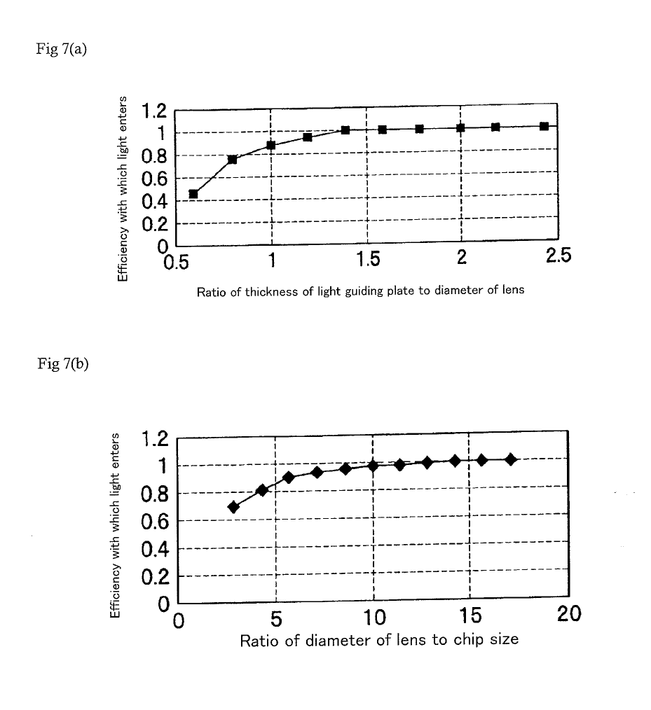

FIG. 7(a) is a graph showing the relationship between the ratio of the thickness B of the light guiding plate 121 to the diameter A of the lenses 124c and the efficiency with which light enters, and shows that the greater the value of the ratio (B/A) of the thickness B of the light guiding plate 121 to the diameter A of the lenses 124c is, the higher the efficiency with which light enters is.

The present embodiment is formed so that the above described ratio (B/A) is 1 or greater, preferably 1.2 or greater. That is to say, the ratio of the thickness B of the light guiding plate 121 to the diameter A of the lenses 124c is 1 or greater, and therefore, as is clear from FIG. 7(a), the efficiency with which light enters the light guiding plate 121 remains 80% or higher, and thus the state is such that most of the light emitted from the LED's 124a enters the light guiding plate 121. Accordingly, when this configuration is applied to a liquid crystal panel 120 for a large screen, for example, a liquid crystal display device 1 with high and uniform brightness on the surface can be gained.

In addition, FIG. 7(b) is a graph showing the relationship between the ratio of the diameter A of the lenses 124c to the chip size C of the LED's 124a in the direction of the thickness of the light guiding plate 121 (see FIG. 5) and the efficiency with which light enters, and shows that the greater the value of the ratio (A/C) of the diameter A of the lenses 124c to the chip size C of the LED's 124a is, the higher the efficiency with which light enters is.

The present embodiment is formed so that the above described ratio (A/C) becomes 5 or greater (A/C □5), preferably 7 or greater (A/C □7). That is to say, the ratio (A/C) of the diameter A of the lenses 124c to the chip size C of the LED's 124a is 5 or greater, and therefore, as is clear from FIG. 7(b), the efficiency with which light enters the light guiding plate 121 remains 80% or higher (more specifically, up to approximately 90%, which is greater than 80% by 10%), and thus, the state is such that most of the light emitted from the LED's 124a enters the light guiding plate 121. Accordingly, when this configuration is applied to a liquid crystal panel 120 for a large screen, for example, a liquid crystal display device 1 with high and uniform brightness on the surface can be gained.

In addition, in the present embodiment, optical sheets 134 are provided between the liquid crystal panel 120 and the light guiding plate 121, as described above, and the length L1 of the light guiding plate 121 is greater than the length L3 of the liquid crystal panel 120, and at the same time, the length L4 of the optical sheets 134 is greater than the length L1 of the light guiding plate 121 in the configuration, and therefore, the following working effects can be gained.

That is to say, the length L4 of the optical sheets 134 is greater than the length L1 of the light guiding plate 121, and therefore, light beams that are converted to light from a surface light source by the light guiding plate 121 enter the optical sheets 134 without leaking, and thus, appropriate correction is carried out on the optical sheets 134, so that a predetermined distribution can be gained in the brightness.

In addition, the length L4 of the optical sheets 134 is greater than the length L3 of the liquid crystal panel 120, and therefore, light passes uniformly through the liquid crystal panel 120, and thus, a liquid crystal display device 1 with high and uniform brightness in a plane can be gained.

In the following, the effects gained in the present embodiment are described.

(1) The distance D between the lenses 124c of the light source modules 124 and the entrance surfaces 121a of the light guiding plate 121 can be kept appropriate, and contact between these can be prevented even when the positional relationship changes due to the difference in temperature between when the light is turned on and when the light is turned off. Accordingly, a liquid crystal display device 1 having excellent uniformity in the brightness, so that the display performance of the liquid crystal can be increased, can be gained.

(2) Inconsistency in the brightness and lowering of the efficiency with which light enters due to fluctuation in the dimensions of the components resulting from thermal expansion can be prevented, even when the scale of the liquid crystal panel 120 is increased.

(3) The distance D between the lenses 124c of the light source modules 124 and the entrance surfaces 121a of the light guiding plate 121 is kept appropriate, and therefore, the problem with the light guiding plate 121 becoming warped when the light guiding plate 121 makes contact with the lenses 124c can be prevented.

(4) The light source modules 124 are thermally secured to the heat sinks 101 in the configuration, and therefore, heat from the light source modules 124 can be released through the heat sinks 101, and in addition, setting of the distance D, which would otherwise be troublesome, is easy with the structure where heat from the light source modules 124 can be released through the heat sinks 101, as described above.

(5) The distance D between the lenses 124c of the light source modules 124 and the entrance surfaces 121a of the light guiding plate 121 is kept appropriate, and therefore, an effective space can be secured when the parts are assembled, and the efficiency of operation increases, the productivity increases and the yield also increases. That is to say, the effects both of holding the distance D small and constant in order to increase the efficiency with which light enters and of increasing the ease of assembly by securing the clearance can be gained at the same time.

(6) The diameter A of the lenses 124c is set equal to or smaller than the thickness B of the light guiding plate 121, and therefore, loss of light can be prevented, and as a result, the efficiency with which light enters the light guiding plate 121 can be increased. Accordingly, when this is applied to a liquid crystal panel 120 for a large screen, for example, a liquid crystal display device 1 with high and uniform brightness on the surface can be gained.

(7) The ratio (A/C) of the diameter A of the lenses 124c to the chip size C of the LED's 124a is 5 or greater, and therefore, the efficiency with which light enters into the light guiding plate 121 can be kept high, and when this is applied to a liquid crystal panel 120 for a large screen, for example, a liquid crystal display device 1 with high and uniform brightness on the surface can be gained.

(8) The relationship between the length L1 of the light guiding plate 121, the length L4 of the optical sheets 134 and the length L3 of the liquid crystal panel 120 satisfies: length L4 of optical sheets 134>length L1 of light guiding plate 121>length L3 of liquid crystal panel 120, and therefore, appropriate correction can be carried out on the optical sheets 134, so that a predetermined distribution can be gained in the brightness and light from the optical sheets 134 uniformly passes through the liquid crystal panel 120, and thus, a liquid crystal display device 1 with high and uniform brightness on the surface can be gained.

Here, the materials and dimensions for the light guiding plate 121, the lenses 124c, the substrates 123, the heat sinks 101 and the lower chassis 122 are not limited to those described above, and appropriate ones can be selected.

1. A liquid crystal display device, comprising:
a support member:
a heat releasing member provided on this support member;
a light guiding plate provided on a rear surface of a liquid crystal panel; and
a light source module which is thermally secured to said heat releasing member so as to face an entrance surface formed on one or two sides in the direction of the length of said light guiding plate and has a light source for emitting a light beam toward said entrance surface, characterized in that
said light source is covered with a lens in said light source module, and
the distance D between said lens and said entrance surface when said light source module is not driven is set within a range found using the following formulas (1) and (2):
{(□×L1)−(□×L2)}n×□T=D1 (1)
D1□D□D1×3 (2)
□: coefficient of thermal expansion of light guiding plate
L1: length of light guiding plate
□: coefficient of thermal expansion of support member
L2: length of support member in direction of length of light guiding plate
n: variable (1 in case where entrance surface formed on one side, ½ in case where entrance surface formed on two sides)
□T: difference in temperature (temperature of heat releasing member−ambient temperature around liquid crystal display device)

2. The liquid crystal display device according to claim 1, characterized in that the diameter of said lens is set equal to or smaller than the thickness of said light guiding plate.

3. The liquid crystal display device according to claim 2, characterized in that said light source comprises an LED, and when the diameter of said lens is A and the size of said light guiding plate in the direction of the thickness is C in said LED, the ratio (A/C) of the diameter A of said lens to the size C of said light guiding plate in the direction of the thickness in said LED satisfies A/C □5 in the configuration.

4. The liquid crystal display device according to claim 1, characterized in that an optical sheet is provided between said liquid crystal panel and said light guiding plate, the length of said light guiding plate is greater than the length of said liquid crystal panel, and the length of said optical sheet is greater than the length of said light guiding plate.
